(19) United States
(12) Patent Application Publication
(10) Pub. No.: US 2008/0015932 A1
(43) Pub. Date: Jan. 17, 2008

(54) METHODS AND APPARATUS TO DISTRIBUTE MEDIA CONTENT

(76) Inventors: ANTHONY HAEUSER, AURORA, IL (US); MARY MCCARTHY, SAN ANTONIO, TX (US); SCOTT PETTIT, SAN ANTONIO, TX (US); CHRISTOPHER LEE, LAKEWOOD, CO (US); ROLAND NOLL, SAN ANTONIO, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/457,309

(22) Filed: Jul. 13, 2006

(51) Int. Cl. G06Q 30/00; H04N 7/10

(52) U.S. Cl. 705/14; 725/32

(57) ABSTRACT

Methods and apparatus to distribute and present media content including triggers are disclosed. An example method includes receiving media content including triggers at a consumer location, determining that the media content includes triggers, presenting an indicator, receiving a request to activate the trigger, and performing an action associated with the trigger. Example actions include initiating a voice enabled telecommunication session, initiating a recording of the media content at a video recorder, initiating a playback of media content at a video recorder, and subscribing to a service.

### FIELD OF THE DISCLOSURE

The present disclosure relates generally to media systems and, more particularly, to methods and apparatus to distribute media content.

### BACKGROUND

Interactive television services enable consumers to be more closely involved in the television consumption experience. In general, interactive television services enable two-way communication between a service provider and a consumer location (e.g., a household, a business, etc.). For example, interactive television services enable a consumer to request information from and to submit information to an interactive television distribution network. One implementation of an interactive television service is an internet protocol television (IPTV) service.

IPTV services provide television media content over a broadband network, such as a cable network or a digital subscriber line (DSL) network. In general, an IPTV provider receives media content from media content creators and then converts the media content into packetized digital media streams. The packetized digital media streams are distributed to consumer locations via an internet protocol (IP) multicast or an IP unicast. Consumer locations each include a consumer device that receives the packetized digital media streams and converts the streams into media content suitable for display on a television. The consumer device communicates with the IPTV provider over an IP connection and, thus, the consumer device can easily transmit data back to the IPTV provider. In other words, the IPTV provider and the consumer device can engage in two-way communication over one or more networks.

### BRIEF DESCRIPTION OF THE DRAWINGS

FIG. 1 is a block diagram of an example telecommunication system for distributing media content including triggers.

FIG. 2 is a block diagram of an example implementation of the receiver of FIG. 1.

FIG. 3 is a block diagram of an example implementation of the trigger inserter 104 of FIG. 1.

FIG. 4 is a flowchart representative of an example process that maybe used to implement the receiver of FIG. 1.

FIG. 5 is a flowchart representative of another example process that may be used to implement the receiver of FIG. 1.

FIG. 6 is a flowchart representative of another example process that may be used to implement the receiver of FIG. 1.

FIG. 7 is a block diagram of an example telecommunication system for distributing media content including triggers.

FIG. 8 is an example processor system that may be used to carry out the processes of FIGS. 4-5 to implement the example methods and apparatus described herein.

### DETAILED DESCRIPTION

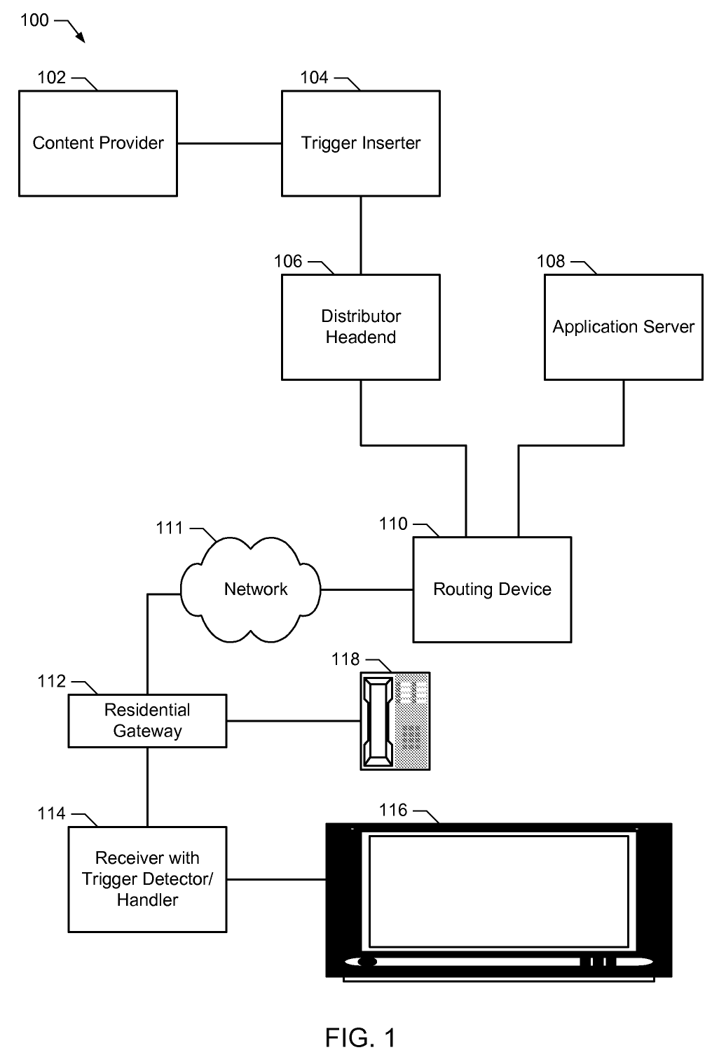

An example telecommunication system 100 for distributing and presenting media content is illustrated in FIG. 1. In general, the example methods and apparatus described herein may be used to present media content to consumers. In one example, the media content stream and/or a related data stream includes triggers that associate the media content with additional content, applications, etc. In particular, according to an example implementation, a content provider inserts a trigger into media content indicating that additional content is available. When the media content is received by a receiver at a consumer location (e.g., a household, a business, etc.), the receiver detects and processes the trigger and displays an indicator on a consumer display device. If the consumer selects the indicator, the additional content is displayed for the consumer. For example, selecting an indicator may, for example, cause an application on a consumer's device to be executed and displayed on the consumer display device, may cause a voice enabled telecommunications session (e.g., a voice over internet protocol (VoIP) telephone call) between the consumer location and another location to be initiated, may cause the consumer to be subscribed to a service (e.g., a pay-per-view television program, an upgraded media distribution package, etc.), may cause the presented media content to change, may cause the presented media content to be stored for later presentation, etc.

The example telecommunication system 100 of FIG. 1 includes a content provider 102, a trigger inserter 104, a distributor headend 106, an applications server 108, a routing device 110, a network 111, a residential gateway 112, a receiver with trigger detector/handler (“receiver”) 114, a display device 116, and a telecommunications device 118. Of course, the example telecommunication system 100 is merely one example of a communication system and other communications systems may include more or fewer components than are shown in FIG. 1.

In operation, the content provider 102 receives and/or creates media content and transmits the media content to a distributor (e.g., distributor 106). The media content may be video and/or audio media content. For example, the content provider 102 may be a television studio, a movie studio, a television network (e.g., ABC, CBS, HBO, etc.), a television station, a radio station, etc. In the illustrated example, the content provider 102 submits the media content to trigger inserter 104 before the media content is transmitted to the distributor headend 106. Alternatively, the content provider 102 may transmit media content directly to the distributor headend 106 if the content provider 102 will not be responsible for inserting triggers (e.g., when the distributor headend 106 will insert the triggers.).

The trigger inserter 104 receives media content from the content provider 102, inserts one or more triggers in the media content, and transmits the media content to the distributor headend 106. In one example, the trigger inserter 104 inserts a trigger by embedding a link to the trigger result in the header of the media content. For example, the trigger inserter 104 may insert a link that points to an application on the applications server 108 and/or an application stored on the receiver 114. Additionally or alternatively, the trigger inserter 104 may embed executable instructions in the media content. These executable instructions can be executed by the receiver 114 to cause a desired result upon detection of the trigger. For example, the executable instructions may implement a game that the user can play, may cause the receiver 114 to select different media content for presentation, may cause the receiver 114 to store the presented media content for later presentation, etc. In one example, the media content may be packetized digital signals that are compressed and encoded. The media content packets may include motion pictures experts group (MPEG) compressed information, such as I-frames, P-frames, and/or B-frames. I-frames include an initial image or frame of video, P-frames include the differences between an I-frame and the next frame of the video, and B-frames are bi-directionally encoded frames that may be determined by analyzing either prior or subsequent frames. Each I-frame and P-frame packet includes header information that describes the packet, indicates the order of the packets, etc. In one example, the trigger link is inserted in the header of the I-frames, P-frames, and/or B-frames.

In addition or as an alternative to embedding triggers in media content, the trigger inserter 104 may generate a separate stream of trigger data. In such instances, the receiver 114 will receive or subscribe to both a media content stream and a trigger data stream. The stream of trigger data may include information that indicates at what time each trigger in the trigger data should be presented. Alternatively, the stream of trigger data may be synchronized with a media content stream so that triggers are presented as they are received. The stream of trigger data is transmitted to the distributor headend 106 for distribution to consumer locations.

If the media content received from the content provider 102 includes access restrictions (e.g., copy protection, digital rights managements (DRM), etc.), the trigger inserter 104 of the illustrated example will remove the access restrictions (e.g., strip off DRM protections) before inserting the trigger(s). Then, after the trigger(s) have been inserted, the trigger inserter 104 will replace the access restrictions or provide new access restrictions to prevent unauthorized access and/or use of the media content. Alternately, if the media content received from the content provider 102 does not include access restrictions, the trigger inserter 104 will insert trigger(s). Then, after the trigger(s) have been inserted, the trigger inserter 104 may inserter access restrictions or may transmit the media content without access restrictions. In another alternative, if the media content received from the content provider 102 includes access restrictions, the trigger inserter 104 will remove the access restrictions and insert trigger(s). Then, after the trigger(s) have been inserted, the trigger(s) inserter 104 may transmit the media content without replacing the access restrictions.

While the example trigger inserter 104 is illustrated as a discrete component, the trigger inserter 104 may be coupled/integrated with another component of the telecommunications network 100. For example, the trigger inserter 104 may be integrated with the content provider 102, the distributor headend 106, the receiver 114, or any other device. In particular, the trigger inserter may be implemented using hardware and/or hardware executing software and/or firmware.

The distributor headend 106 receives media content and/or trigger data streams from one or more sources (e.g., the content provider 102 and/or trigger inserter 104) and processes the media content for distribution to consumer locations. For example, the distributor headend 106 may receive media content, decode the media content, re-encode the media content in a format that consumer receivers can utilize, encrypt the media content, and transmit the media content to consumer locations. For example, the distributor headend 106 may re-encode the media content in Microsoft® VC1 format. The media content may be distributed as a digital data stream or using any other type of transmission.

In the illustrated example, the distributor headend 106 is an IPTV distributor and transmits media content to consumer locations via the routing device 110. The example distributor headend 106 may also be referred to as a video hub office. Additionally or alternatively, the distributor headend 106 may transmit another stream of triggered data to consumer locations via the routing device 110. Alternatively, the distributor headend 106 may be any type of media content distributor such as, for example, a cable media content distributor, a satellite media content distributor, a broadcast media content distributor, etc.

The application server 108 stores and executes software applications and transmits the results (e.g., a user interface and/or output from the software applications) to consumer locations via the routing device 110. For example, the application server may execute an application that generates a voting user interface or an advertising display. In another example, the application server may execute an application that implements a game or user productivity software (e.g., a word processing application). In another example, the application server 108 may execute an application that instructs the residential gateway 112 to initiate a telecommunication session (e.g., a voice enabled telecommunication session such as a VoIP telephone call). Using two-way communication, the application server 108 can provide an interactive interface for the display device 116 via the receiver 114.

In the illustrated example, the application server 108 is a discrete component; however, alternatively, the application server 108 may be integrated with another component of the telecommunication system 100. For example, the application server 108 may be integrated with and/or located within the distributor headend 106, the residential gateway 112, or the receiver 114. The application server 108 may be implemented as hardware and/or hardware executing software and/or firmware.

The routing device 110 communicatively couples the distributor headend 106 and the application server 108 with the residential gateway 112 via the network 111. In one example, the routing device 110 is a digital subscriber line access module (DSLAM). Alternatively, the routing device 110 may be implemented by any other communication device such as, for example, a communication device for a cable distribution system, a communication device for a satellite broadcasting system, a communication device for a radio frequency (RF) broadcasting system, etc. In the illustrated example, the routing device 110 is a discrete component; however, alternatively, the routing device 110 may be integrated with another component of the telecommunication system 100. For example, the routing device 110 may be integrated with the distributor headend 106 and/or the application server 108. The routing device 110 may be implemented as hardware and/or hardware executing software and/or firmware.

The network 111 may be any type of network capable of communicatively coupling the residential gateway 112 with the routing device 110. For example, the network 111 may be the Internet, a communication distributor network (e.g., a network for a cable communications provider, a network for a telephone communications provider, a network for a fiber optic communications provider, etc.), any private network, any public network, etc.

The residential gateway 112 communicatively couples a consumer location with the routing device 110 via the network 111. The residential gateway 112 receives media content and data streams from the routing device 110 and directs the communications to the receiver 114 and the telecommunications device 118. In the illustrated example, the residential gateway is a digital subscriber line (DSL) network interface such as, for example, an asynchronous DSL (ADSL) transmission unit—remote (ATU-R). The residential gateway 112 may alternatively be a cable modem, a satellite communications interface, a broadcast communications interface, etc. In the illustrated example, the residential gateway 112 is a discrete component; however, alternatively, the residential gateway 112 may be integrated with another component of the telecommunication system 100. For example, the residential gateway 112 may be integrated with the telecommunications device 118 and/or the receiver 114.

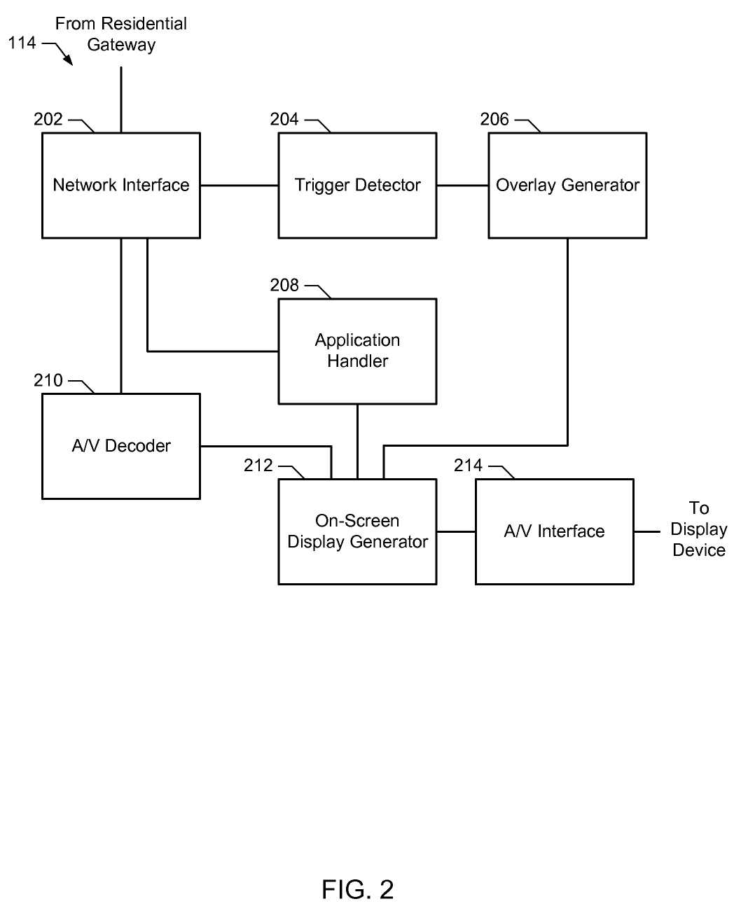

The receiver 114, which is shown in further detail in FIG. 2, receives media content and/or data streams from the residential gateway 112 and presents media content on the display device 116. For example, the receiver 114 may subscribe to a media content stream including triggers and/or may subscribe to a first stream of media content and may also receive a second stream of trigger data. In addition, the receiver 114 monitors received/presented media content and/or data streams for embedded triggers. If an embedded trigger is discovered, the receiver 114 presents an indicator (e.g., audio or visual information) on the display device 116 indicating that trigger content is available. If the consumer selects the indicator, the receiver 114 performs any necessary actions associated with (e.g., instructions embedded in) the trigger (e.g., selects different media content for presentation, contacts the application server 108, subscribes to services, records media content, transmits voting/survey answers, etc.) and presents information associated with the trigger (e.g., an application user interface). The receiver may be implemented using a set top box, an integrated receiver/decoder, a personal computer, a laptop computer, a media content computer, etc. As noted previously, the receiver 114 is described in further detail in conjunction with the description of FIG. 2.

The display device 116 presents media content received from the receiver 114 to consumers at a consumer location. In the illustrated example, the display device 116 is a television such as, for example, a standard definition television, an enhanced definition television, a high-definition television, a cathode ray tube (CRT) television, a liquid crystal display (LCD) television, a plasma television, a projection television, an organic light emitting diode (OLED) television, a surface-conduction electron-emitter display (SED) television, etc. Alternatively, the display device 116 may be any other device that is capable of receiving and presenting media content such as, for example, any type of radio receiver/player, a projector, a monitor, a computer, a portable media player (e.g., an iPod®), a desktop computer, a laptop computer, etc.

The example telecommunication device 118 enables audio communication between a consumer location and a telecommunication device at another location. For example, the telecommunication device 118 may be a voice over internet protocol (VoIP) telephone or a public switched telephone network (PSTN) telephone. The example residential gateway 112 is capable of initiating a call for the telecommunication device 118. For example, if the telecommunication device 118 is a VoIP telephone, the residential gateway 112 may be capable of contacting another telephone (e.g., via a VoIP connection or a PSTN connection) and causing the telecommunication device 118 to ring. In this way, the residential gateway 118 and the telecommunication device 118 can initiate a call without requiring a consumer to manually initiate a call. The telecommunication device 118 may be any type of communication device including a text messaging device, a cellular telephone that is associated with the residential gateway 112 (e.g., linked to the residential gateway 112 via the routing device 110), a computer including a text messaging interface, etc.

FIG. 2 is a block diagram of an example implementation of the receiver 114 of FIG. 1. The example receiver 114 includes a network interface 202, a trigger detector 204, an overlay detector 206, an application handler 208, an audio/video decoder 210, an on-screen display generator 212, and an audio/video interface 214. Of course, in accordance with other examples of receivers, such receives may include more or fewer components and/or may include more than one of any of the components. For example, the receiver 114 may include a second one of the audio/video decoder 210.

The network interface 202 enables the receiver 114 to communicate with other devices on a network. For example, the receiver 114 may communicate with the residential gateway 112 or the routing device 110 using the network interface 202. In particular, in the illustrated example, the receiver 114 receives media content and/or data streams including triggers from the distributor headend 106 via the residential gateway 112 and the routing device 110 using the network interface 202. The receiver 114 of the illustrated example also communicates with the application server 108 using the network interface 202. Media content and/or data streams received by the network interface 202 are transmitted to the trigger detector 204, the application handler 208, and the audio/video decoder 210.

The trigger detector 204 of the illustrated example receives media content and/or data streams from the network interface 202 and monitors the media content and/or data streams for the presence of triggers. If the media content and/or data streams include encryption and/or access restrictions, the trigger detector 204 will decrypt the media content and/or data streams and/or remove the access restrictions. The example trigger detector 204 monitors the headers of packets received for the media content and/or data streams to determine if the header includes a trigger indicator (e.g., a flag). Alternatively, the trigger detector 204 may monitor a stream of packets to determine if the stream includes trigger packets (e.g., packets including content in addition to the media content that may be presented in response to a user selecting an on-screen trigger indicator). When the trigger detector 204 of the illustrated example detects the presence of a trigger, the trigger detector 204 transmits a message to the overlay generator 206 indicating that the overlay generator 206 should output a trigger indicator overlaid on the media content for display on the display device 116.

The overlay generator 206 of the illustrated example receives trigger presence messages from the trigger detector 204 and generates a trigger indicator overlay for display on the display device 116. For example, the example overlay generator 206 may load a graphic of the letter “I” stored in a memory (not shown) and transmit the graphic to the on-screen display generator 212. Alternatively, the message indicating the presence of a trigger received from the trigger detector 204 may include a graphic or text (e.g., a graphic or text that was included with the trigger indicator in received media content or data streams) that is to be used as the trigger indicator.

The application handler 208 of the illustrated example, interacts with the application server 108 via the network interface 202. For example, when a consumer selects a trigger indicator (e.g., highlights the trigger indicator on the screen and select enter using a remote control) the application handler receives the input and, using a location specified by the trigger, transmits a request for an application execution to the application server 108. When the application server 108 returns an interface for the application, the application handler 208 transmits the interface of the application to the on-screen display generator 212 for display. The application handler 208 may receive user input from a remote control, a voice activation module, an attached or wireless keyboard, user input controls on the receiver 114, or any other type of user input.

The audio/video decoder 210 receives media content from the network interface 202 and prepares the media content for display. For example, the audio/video decoder 210 may decode, demodulate, decrypt, remove access restrictions, etc. The audio/video decoder 210 may be coupled with a conditional access module (not shown) to enable the audio/video decoder 210 to access restricted media content that the receiver 114 is authorized to present. The audio/video decoder 210 may be any type of media content decoder including an IPTV media content decoder, a cable television media content decoder, a satellite television media content decoder, a broadcast television media content decoder, etc. Media content that is prepared by the audio/video decoder 210 is transmitted to the on-screen display generator 212 for display on the display device 116.

The on-screen display generator 212 of the illustrated example receives media content and user interface objects from one or more of the overlay generator 206, the application handler 208, and the audio/video decoder 210. The on-screen display generator 212 combines the media content to provide a display for output to the display device 116. For example, the overlay generator 206 may provide a graphical icon with a transparent background that the on-screen display generator 212 may place over media content received from the audio/video decoder 210. Additionally, the application handler 208 may provide a user interface object having a transparent background that the on-screen display generator 212 may place over media content received from the audio/video decoder 210. The example on-screen display generator 212 also generates and presents other user interface components such as control menus and electronic program guide information. The display generator by the on-screen display generator 212 transmitted to the display device 116 via the audio/video interface 214.

The audio/video interface 214 communicatively couples the receiver 114 with the display device 116. Audio/video display interface generated by the on-screen display generator 212 is transmitted to the display device 116 via the audio/video interface 214. In addition, if the display device 116 is capable of transmitting information to the receiver 114, the audio/video interface 214 receives such information. The audio/video interface 214 may utilize any type of connection to the display device 116 such as, for example, a high-definition multimedia interface (HDMI), a universal serial bus (USB) connection, a IEEE 1394 (FireWire) connection, a composite video connection, a component video connection, a optical connection, a digital visual interface (DVI) connection, a network connection (e.g., a network that supports Universal Plug and Play (UPnP)), an S-Video connection, a radio-frequency (RF) connection, any type of digital connection, any type of analog connection, etc.

Having described the architecture of one example system that may be used to provide dynamic messaging services, various processes are described. Although the following discloses example processes, it should be noted that these processes may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. For example, instructions representing some or all of the blocks shown in the flow diagrams may be stored in one or more memories or other machine readable media, such as hard drives or the like. Additionally, some portions of the process may be carried out manually. Furthermore, while each of the processes described herein is shown in a particular order, those having ordinary skill in the art will readily recognize that such an ordering is merely one example and numerous other orders exist. Accordingly, while the following describes example processes, persons of ordinary skill in the art will readily appreciate that the examples are not the only way to implement such processes.

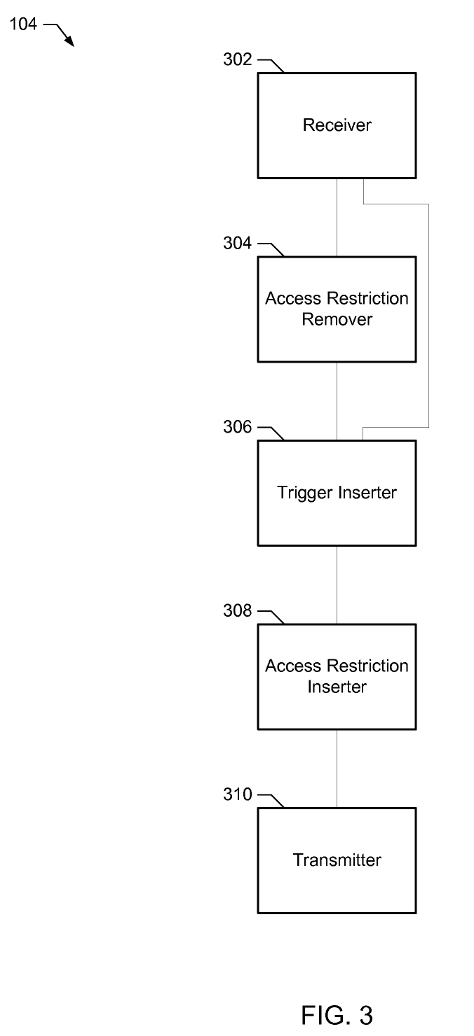

FIG. 3 is a block diagram of an example implementation of the trigger inserter 104 of FIG. 1. The example trigger inserter 104 includes a receiver 302, an access restriction remover 304, a trigger inserter 306, an access restriction inserter 308, and a transmitter 310.

The example receiver 302 receives media content and/or trigger information from the content provider 102 and transmits the media content to the access restriction remover 304 and/or the trigger information to the trigger inserter 306. The example receiver 302 may be implemented using any type of receiver capable of communicatively coupling the trigger inserter 104 and the content provider 102. For example, the receiver 302 may be a network receiver, a network transceiver, a universal serial bus (USB) receiver and/or transceiver, a serial receiver and/or transceiver, an IEEE 1394 Firewire receiver and/or transceiver, etc.

The example access restriction remover 304 receives media content and, if the media content includes access restrictions, removes the access restrictions from the media content. For example, the access restriction remover 304 may remove DRM access restrictions from the media content. In addition, the access restriction remover 304 may decrypt of decode to media content if such decoding or decryption will enable the trigger inserter 308 to insert triggers in the media content. After the access restrictions have been removed from the media content, the access restriction remover 304 transmits the media content to the trigger inserter 306.

The example trigger inserter 306 receives media content from the access restriction remover 304 and inserts triggers in the media content as described in conjunction with the description of FIG. 1. In the illustrated example, information describing the triggers is received from the receiver 302. Alternatively, information describing the triggers may be received from the receiver via the access restriction remover 304 or from any other available source of information. In an alternative example, the trigger inserter 306 receives media content directly from the receiver 302 (e.g., when the media content does not include access restrictions and/or when the trigger inserter 306 can insert triggers in media content that includes access restrictions).

The example access restriction inserter 308 receives media content including triggers from the trigger inserter 306 and inserts access restrictions in the media content including triggers. For example, the access restriction inserter 308 may insert DRM access restrictions. Additionally or alternatively, the access restriction inserter 308 may encode and/or encrypt the media content. The access restriction inserter 308 may not be used if access restrictions, encoding, and/or encryption are not desired. After processing the media content including triggers, the access restriction inserter 308 transmits the media content including triggers to the transmitter 310.

The example transmitter 310 receives media content including triggers from the access restriction inserter 308 (or the trigger inserter 306 if access restrictions are not added to the media content) and transmits the media content to the distributor headend 106. The example transmitter 310 may be implemented using any type of receiver capable of communicatively coupling the trigger inserter 104 and the distributor headend 106. For example, the transmitter 310 may be a network transmitter and/or transceiver, a universal serial bus (USB) transmitter and/or transceiver, a serial transmitter and/or transceiver, an IEEE 1394 Firewire transmitter and/or transceiver, etc. Alternatively, the transmitter 310 may transmit the media content including triggers to the content provider 102 (e.g., when the content provider 102 will transmit the media content to the distributor headend 106) or to any other network component.

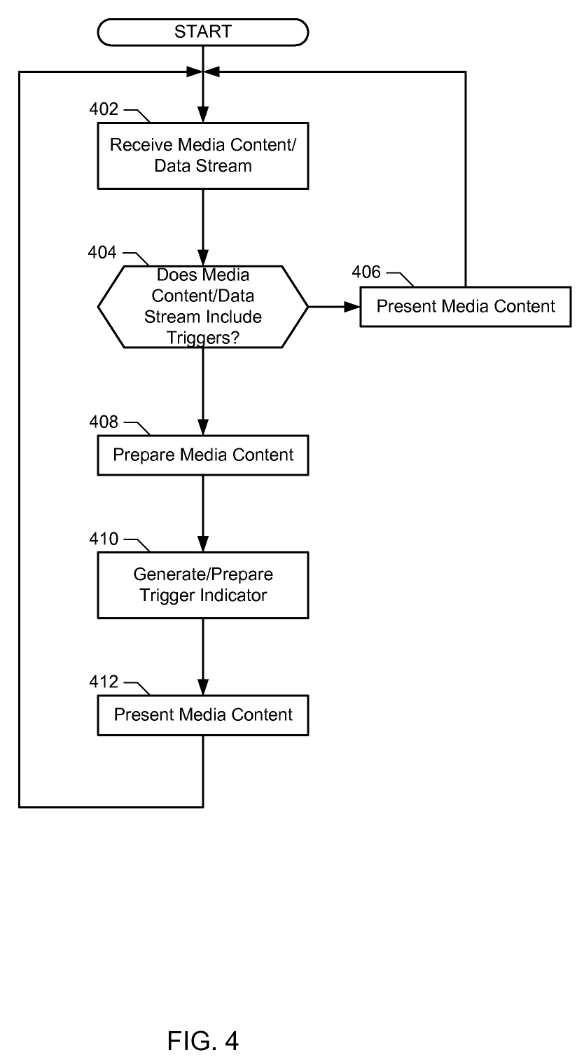

FIG. 4 is a flowchart of an example process that may be used to implement the receiver 114. In general, the example process causes the receiver 114 to receive and display a trigger indicator on the display device 116. The execution of the flowchart in FIG. 4 begins when the network interface 202 of FIG. 2 receives media content and/or data streams (block 402). The trigger detector 204 monitors the media content and/or data streams to determine if the media content and/or data streams include triggers (block 404). For example, the trigger detector 204 may monitor the headers of packets of media content to determine if a trigger has been inserted in the media content headers. In another example, the trigger detector 204 may monitor for the presence of a data stream providing a trigger. If a trigger is not detected by the trigger detector 204 (block 404), the audio video decoder 210 prepares the media content for presentation and the media content is presented via the on-screen display generator 212 and the audio/video interface 214 (block 406). Control then proceeds to block 402 to continue receiving media content and/or data streams.

If a trigger is detected by the trigger detector 204, the audio video decoder 210 prepares the media content for display and transmits the media content to the on-screen display generator 212 (block 408). Next or simultaneously, the overlay generator 206 generates or prepare the trigger indicator (block 410). For example, the overlay generator 206 may retrieve a stored trigger indicator, may generate a trigger indicator using information in the trigger, may retrieve a trigger indicator provided in conjunction with the trigger, etc.

Once the on-screen display generator 212 receives the trigger indicator from the overlay generator 206 and the media content from the audio/video decoder 210, the on-screen display generator 212 combines the media content and the trigger indicator and transmits the combination to the display device 116 via the audio/video interface 214 (block 412). Control then proceeds to block 402 to continue monitoring and presenting media content.

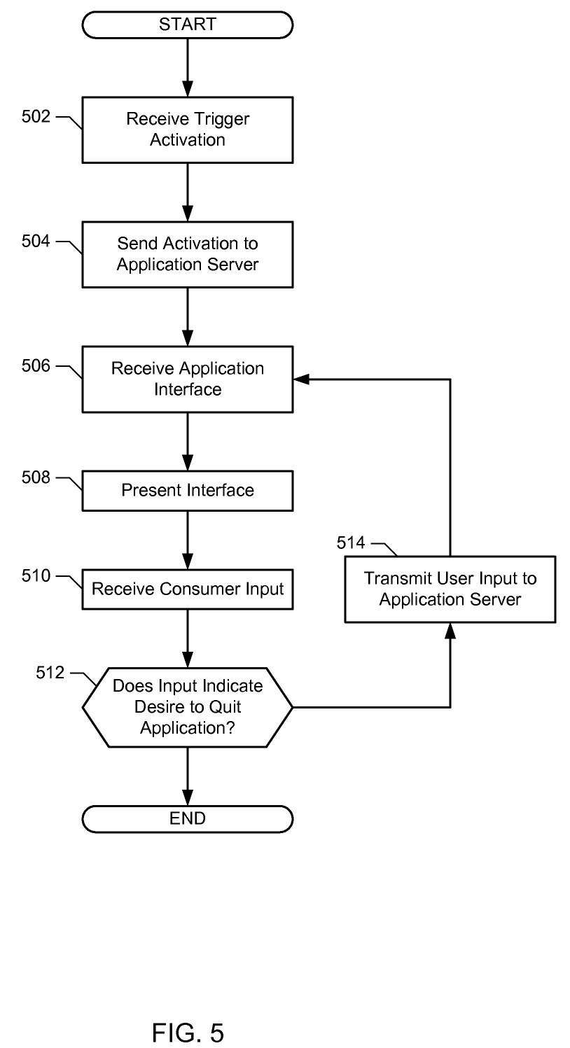

FIG. 5 is a flowchart of another example process to implement the receiver 114 of FIG. 1. In general, the example process causes the receiver 114 to handle a trigger selection (e.g., a request for execution of an application) by a consumer. The execution of the flowchart in FIG. 5 begins when the application handler 208 of FIG. 2 of the receiver 114 of FIG. 1 receives a trigger activation (block 502). For example, after a trigger indicator is displayed on the display device 116, a consumer may use a remote control to highlight and select the trigger indicator. The application handler 208 transmits the trigger activation to the application server 108 (block 504). For example, the trigger may include a network address to the application server and the application handler 208 may transmit a request including the network address of the receiver 114 to the application server 108.

The application handler 208 then receives the user interface generated by the application executing at the application server 108 (block 506). In other words, execution of the flowchart of FIG. 5 may be delayed while the application executes at the application server 108. The application handler 208 then transmits the user interface to the on-screen display generator 212 for display on the display device 116 via the audio/video interface 214 (block 508). The application handler 208 then receives further user input from the consumer (block 510). The application handler 208 determines if the user input indicates that the consumer would like to end the display of the user interface (block 512). For example, the consumer may select a quit button on the screen or may press a quit button the remote control. If the user input indicates that the consumer would like to close the user interface (block 512), the execution of the flowchart in FIG. 5 ends.

If the user input does not indicate that the consumer would like to close the user interface (block 512), the user input from the consumer is transmitted to the application server 108 by the application handler 208 (block 514). For example, if the executed application is a game, the user input may indicate that the user would like to move a displayed graphical character. The application server 108 will apply the user input to the application and transmit the updated user interface to the application handler 208. Control proceeds to block 506 to continue receiving an updated user interface and user input from the consumer.

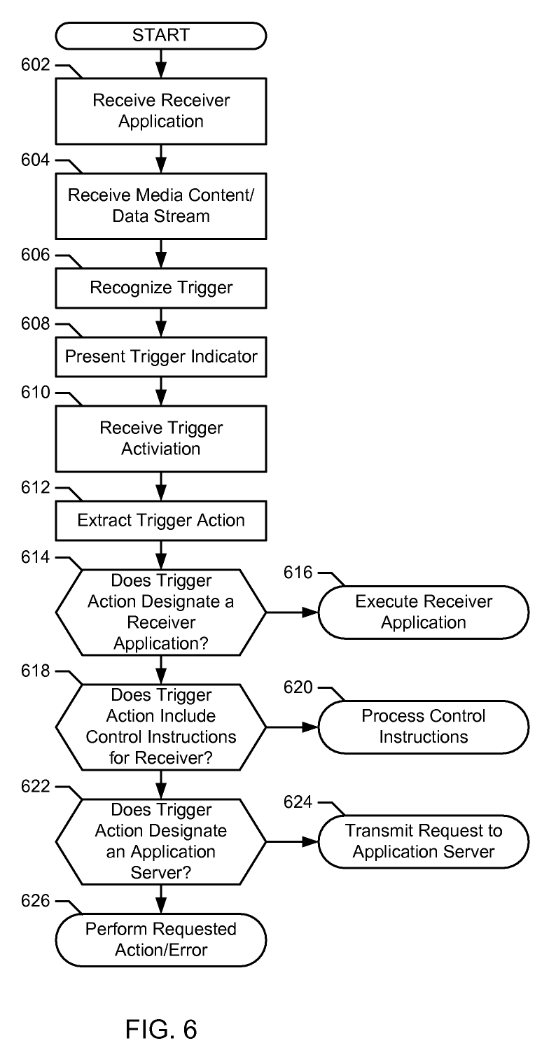

FIG. 6 is a flowchart of an example process to handle various types of triggers at the receiver 114 and/or the distributor headend 106. The flowchart of FIG. 6 begins when the receiver 114 receives a receiver application (block 602). A receiver application comprises machine readable instructions that are to be executed by the receiver 114. For example, the machine readable instructions may be executed by the application handler 208. The machine readable instructions may be transmitted with a trigger or the trigger may indicate a location where the receiver 114 can download the machine readable instructions. The machine readable instructions may be stored in a memory (not shown) associated with the receiver 114.

The receiver 114 then receives media content and/or data streams from the distributor headend 106 (block 604). Alternatively, block 604 may be executed simultaneously with block 602 and/or prior to block 602. The trigger detector 204 then recognizes a trigger in the media content and/or the data stream (block 606). While not illustrated in the flowchart of FIG. 6, the receiver 114 may receive a plurality of media content and/or data streams not including triggers before recognizing a trigger in media content and/or data streams.

After recognizing the trigger, the trigger detector 204, the overlay generator 206, and the on-screen display generator 212 operate as previously described to present a trigger indicator on the display device 114 via the audio/video interface 214 (block 608). Then, the application handler 208 receives trigger activation from the consumer (block 610). While not illustrated in the flowchart of FIG. 6, the receiver 114 continues to present media content while waiting for consumer input. Also, the trigger indicator may be presented for a predetermined period of time and, if no consumer input is received, may be removed.

After receiving trigger activation, the application handler 208 extracts the trigger's action (e.g., information specifying the purpose or objective of the trigger) from the trigger (block 612). The application handler 208 then determines what type of action is designated by the trigger (blocks 614, 618, 622). First, the application handler 208 determines if the trigger action designates a receiver application (e.g., the receiver application downloaded in block 602) (block 614). If the trigger action designates a receiver application, the application handler 208 executes the application and presents the application interface (block 616). For example, the application might be a game that a consumer can interact with.

If the trigger action does not designate a receiver application, the application handler 208 determines if the trigger action designates and/or includes control instructions for the receiver (block 618). If the trigger action designates and/or includes control instructions of for the receiver, the application handler 208 causes the control instructions to be executed (block 620). For example, the control instructions might instruct the receiver 114 to select a different media content stream, to select media content stored at the receiver 114 (e.g., media content stored via a video recorder module, etc.).

If the trigger action does not designate and/or include control instructions for the receiver, the application handler 208 determines if the trigger action designates an application located at an application server (e.g., application server 108) (block 622). If the trigger action designates an application located at an application server, the application handler 208 transmits a request to the application server requesting that the application be executed and that the user interface be transmitted to the application handler 208 (block 624). For example, the application may be a voting application that allows a consumer to vote, an application that allows a consumer to complete a survey, a game with which a consumer may interact, etc.

If the trigger action does not designate an application located at an application server, the application handler 114 performs the action designated by the trigger action and/or presents an error if the trigger action cannot be handled (block 626).

While FIG. 6 illustrates a single process of machine readable instructions, persons of ordinary skill in the art will recognize that the machine readable instruction illustrated in FIG. 6 may be executed in a loop to allow the receiver 114 to continuously receive triggers and requests from consumers.

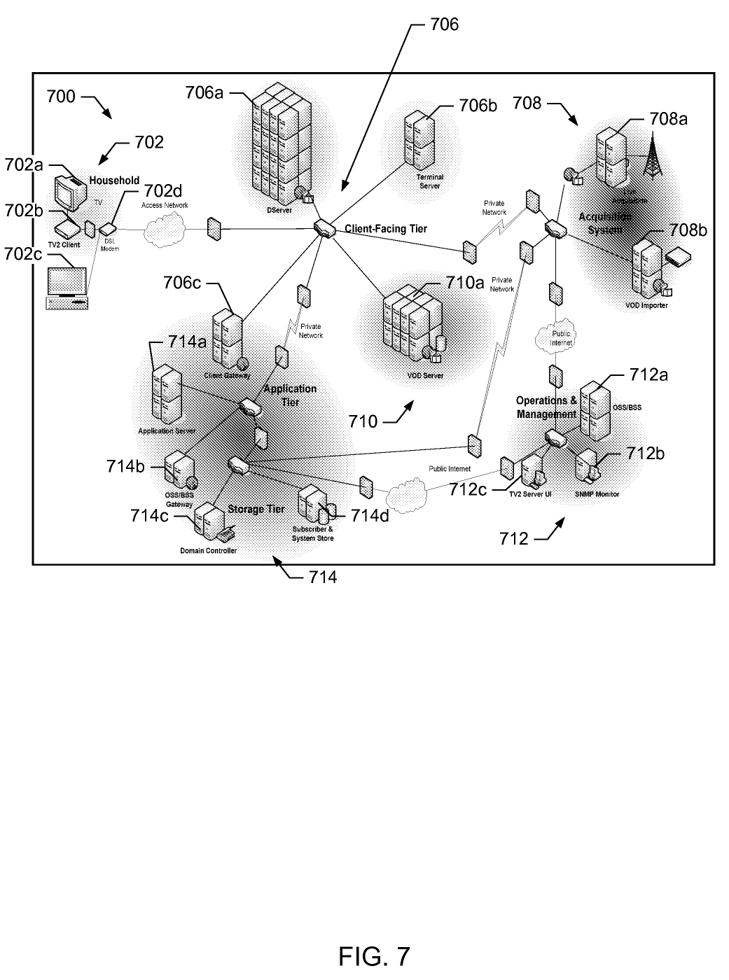

FIG. 7 illustrates an example telecommunication system 700 for providing internet protocol television (IPTV) media content. In general, the telecommunication system 700 includes a household 702, a client facing tier 706, an acquisition system 708, a video on demand system 710, an operations and management system 712, and an application and storage tier 714.

In general, the telecommunication system 700 receives media content from media content creators/distributors via the acquisition system 708. The media content is transmitted to the client facing tier 706. In the client facing tier, the media content is either transmitted to the video on demand system 710 for storage or transmitted to the household 702. The application and storage tier 714 verifies that consumers connecting to the telecommunication system 700 are authorized to access media content and other services provided by the telecommunication system 700 (e.g., internet access, pay per view access, etc.) The application and storage tier additionally transmits usage information (e.g., purchase of a pay per view movie) to the operations and management system 712. The operations and management system provides an interface for the telecommunication system 700 for use by technicians. In addition, the operations and management system 712 tracks billing information associated with media content creators/distributors.

The household 702 is similar to the household 102 of FIG. 1. The household 702a includes a television 702a, a CPE 702b, a computer 702c, and a NTU 702d, which may be similar to the television 110, the CPE 114, the computer 116, and the NTU 112 of FIG. 1, respectively. The devices in the household 702 receive IPTV media content similar to the media content received by the household 102 of FIG. 1.

The client facing tier 706 is similar to the client interface 118 of FIG. 1. The client facing tier 706 comprises a DServer 706a, a terminal server 706b, and a client gateway 706c. The DServer 706a temporarily stores media content as the media content is transmitted to the household 702. The terminal server 706b provides applications that may be executed remotely from the CPE 702b and/or the computer 702c. The client gateway 702c communicates with the CPE 702b and the computer 702c via the NTU 702d.

The acquisition system 708 comprises a live acquisition server 708a and a video on demand (VOD) importer 708b. The live acquisition server 708a acquires media content including triggers and/or data streams (e.g., trigger data streams) from media content creators/distributors, encodes media content, encrypts media content, and encapsulates media content for delivery to the household 702 remote transmission protocols. The VOD importer 708b receives VOD content from media content creators/distributors and stores the media content on the VOD server 710a.

The operations and management system 712 comprises an operational support system/business support system (OSS/BSS) 712a, a simple network management protocol (SNMP) monitor 712b, and a TV2 management system 712c. The OSS/BSS 712a stores billing information associated with media content creators/distributors. The SNMP monitor 712b provides a user interface for technicians to access system errors and messages. The TV2 management system 712c provides management tools for technicians to configure the telecommunication system 700.

The application and storage tier 714 comprises an application server 714a, an OSS/BSS gateway 714b, a domain controller 714c, and a subscriber and system store 714d. The application server 714a provides user interface applications for the CPE 702b. For example, the application server 714a provides a user interface for access to video on demand media content. The OSS/BSS gateway 714b provides an interface between the operations and management system 712 and the application and storage tier 714. The domain controller 714c provides network services such as user authentication, current time announcement, etc. The subscriber and system store 714d stores information associated with consumer media content subscriptions and electronic program guide data.

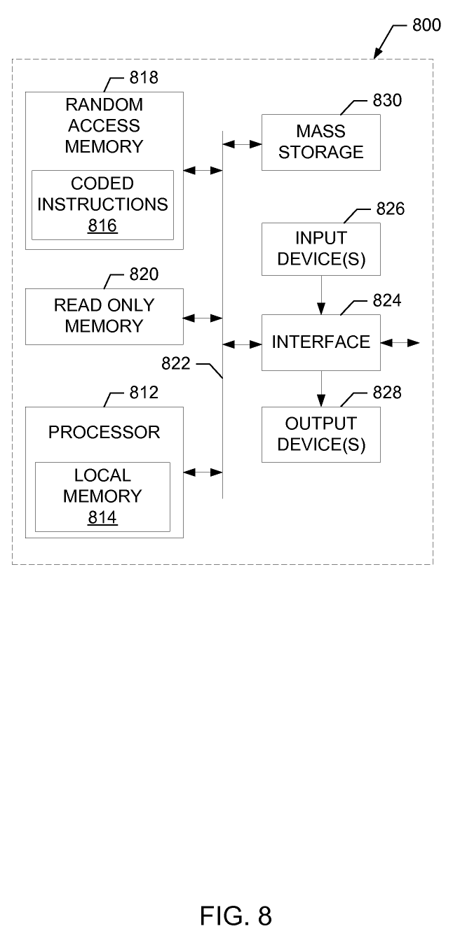

FIG. 8 is a block diagram of an example computer 800 capable of executing the machine readable instructions represented by FIGS. 2 and/or 4 to implement the apparatus and/or methods disclosed herein. The computer 800 can be, for example, the content provider 102, the trigger inserter 104, the distributor headend 106, the application server 108, the routing device 110, the residential gateway 112, the receiver 114, the display device 116, the telecommunication device 118, and/or any part thereof.

The system 800 of the instant example includes a processor 812 such as a general purpose programmable processor. The processor 812 includes a local memory 814, and executes coded instructions 816 present in the local memory 814 and/or in another memory device. The processor 812 may execute, among other things, the machine readable instructions illustrated in FIGS. 4 and 7. The processor 812 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 812 is in communication with a main memory including a volatile memory 818 and a non-volatile memory 820 via a bus 822. The volatile memory 818 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 820 may be implemented by flash memory and/or any other desired type of memory device. Access to the main memory 818, 820 is typically controlled by a memory controller (not shown) in a conventional manner.

The computer 800 also includes a conventional interface circuit 824. The interface circuit 824 may be implemented by any type of well known interface standard, such as an Ethernet interface, a universal serial bus (USB), and/or a third generation input/output (3GIO) interface.

One or more input devices 826 are connected to the interface circuit 824. The input device(s) 826 permit a user to enter data and commands into the processor 812. The input device(s) can be implemented by, for example, a keyboard, a mouse, a touchscreen, a track-pad, a trackball, isopoint and/or a voice recognition system.

One or more output devices 828 are also connected to the interface circuit 824. The output devices 828 can be implemented, for example, by display devices (e.g., a liquid crystal display, a cathode ray tube display (CRT), a printer and/or speakers). The interface circuit 824, thus, typically includes a graphics driver card.

The interface circuit 824 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 800 also includes one or more mass storage devices 830 for storing software and data. Examples of such mass storage devices 830 include floppy disk drives, hard drive disks, compact disk drives and digital versatile disk (DVD) drives.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

Although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
receiving media content at a consumer location;
determining if the media content is associated with a trigger;
presenting an indicator based on the determination;
receiving a request to activate the trigger;
determining a destination associated with the trigger; and
initiating a voice enabled telecommunication session to the destination associated with the trigger.

2. A method as defined in claim 1, wherein the media content is internet protocol television media content.

3. A method as defined in claim 1, wherein the consumer location is at least one of a household or a business.

4. A method as defined in claim 1, wherein receiving the media content comprises receiving a digital data stream comprising media content.

5. A method as defined in claim 1, wherein the voice enabled telecommunication session is a voice over internet protocol telecommunication session.

6. A method as defined in claim 1, wherein the destination is associated with at least one of a telephone number or a network address.

7. A method as defined in claim 1, wherein determining if the media content is associated with a trigger comprises monitoring a header of the media content.

8. A method as defined in claim 1, further comprising causing a telecommunication device at the consumer location to indicate that the voice enabled telecommunication session has been initiated.

9. A method as defined in claim 1, wherein presenting the indicator comprises displaying a graphic indicating that the media content is associated with a trigger on a presentation device at the consumer location.

10. An apparatus comprising:
a network interface to receive media content at a consumer location;
a trigger detector to determine if the media content is associated with a trigger;
an overlay generator to present an indicator based on the determination;
an application handler to receive a request to activate the trigger, to determine a destination associated with the trigger, and to initiate a voice enabled telecommunication session between a consumer location and the destination associated with the trigger.

11. An apparatus as defined in claim 10, wherein the apparatus is at least one of a set top box or an integrated receiver and decoder.

12. An apparatus as defined in claim 10, wherein the media content is internet protocol television media content.

13. An apparatus as defined in claim 10, wherein the consumer location is at least one of a household or a business.

14. An apparatus as defined in claim 10, wherein the voice enabled telecommunication session is a voice over internet protocol telecommunication session.

15. An apparatus as defined in claim 10, wherein the destination is at least one of a telephone number or a network address.

16. An apparatus as defined in claim 10, wherein determining if the media content is associated with a trigger comprises monitoring a header of the media content.

17. An apparatus as defined in claim 10, wherein the application handler is further to cause a telecommunication device at the consumer location to indicate that the voice enabled telecommunication session has been initiated.

18. An apparatus as defined in claim 10, wherein presenting the indicator comprises displaying a graphic indicating that the media content is associated with a trigger on a presentation device at the consumer location.

19. An article of manufacture storing machine readable instructions which, when executed, cause a machine to:
receive media content at a consumer location;
determine if the media content is associated with a trigger;
present an indicator based on the determination;
receive a request to activate the trigger;
determine a destination associated with the trigger; and
initiate a voice enabled telecommunication session between a consumer location and the destination associated with the trigger.

20. An article of manufacture as defined in claim 19, wherein the voice enabled telecommunication session is a voice over internet protocol telecommunication session.

21. An article of manufacture as defined in claim 19, wherein the destination is at least one of a telephone number or a network address.

22. An article of manufacture as defined in claim 19, wherein determining if the media content is associated with a trigger comprises monitoring a header of the media content.

23. An article of manufacture as defined in claim 19, wherein the machine readable instructions further cause a machine to cause a telecommunication device at the consumer location to indicate that the voice enabled telecommunication session has been initiated.

24. An article of manufacture as defined in claim 19, wherein presenting the indicator comprises displaying a graphic indicating that the media content is associated with a trigger on a presentation device at the consumer location.

25-73. (canceled)
